(19) United States
(12) Patent Application Publication
(10) Pub. No.: US 2017/0354896 A1
(43) Pub. Date: Dec. 14, 2017

(54) SPECIAL PURPOSE MANNEQUIN

(71) Applicant: Allen CHEN, Arlington Heights, IL (US)

(72) Inventor: Allen CHEN, Arlington Heights, IL (US)

(21) Appl. No.: 15/177,772

(22) Filed: Jun. 9, 2016

(51) Int. Cl. A63H 3/00; A61H 19/00

(52) U.S. Cl. CPC A63H 3/003; A61H 19/32

(57) ABSTRACT

A mannequin of a human torso adapted to retain otherwise handheld devices for simulation purposes is provided. The mannequin may have a plush shell covering filled with polymer stuffing except for a cavity therein, wherein the cavity communicates to a cavity opening defined by the shell covering. An elastic sleeve may be dimensioned and adapted to line the cavity yet protrude from the cavity opening, so that the sleeve opening is concomitant with the cavity opening. Operatively engaged along a peripheral portion of the sleeve, slightly inward for the sleeve opening, a peripheral drawstring adapted to selectively decrease the peripheral portion of the sleeve is disposed to removably retain the handheld device within the sleeve.

### BACKGROUND OF THE INVENTION

The present invention relates to a special purpose mannequin and, more particularly, to a mannequin of a human torso adapted to retain otherwise handheld penile stimulation devices for functionally simulating intercourse with said mannequin.

Penile stimulation devices are well known in the art. The current market can be broken into two categories. Handheld masturbatory devices and mannequins used for sexual purposes. Current handheld devices cannot be used without the user grasping the device and producing the hand motion needed to simulate intercourse, limiting such devices to a one-dimensional experience with stimulation coming from linear hand movements.

The special-purpose mannequins facilitate a more realistic simulation, in part by incorporating a rigid frame supporting an opening housed within an outer surface shaped like a human. Users of these mannequins, however, must conform their grasps to the contours of the mannequin's outer surfaces, which tend to be a hard or resilient and so results in an unnatural experience.

In addition, repeated usage and excessive force cause tears and compression marks on the outer surface of these mannequins. The outer surfaces, often made of silicon flesh, tend to accrue dirt rather easily due to the fine grain and imperfections inherent in such material. Unfortunately, it is difficult to remove dirt and mildew from this type of surface.

Importantly, the openings of the mannequins are permanently attached to the mannequins because they are supported by the above-mentioned rigid frame, and so do not allow the user to vary their experience without purchasing additional model.

Finally, one of the most common drawbacks of such mannequins is the potential for embarrassment arising out of discovery of the doll by unintended parties, especially children. Another disadvantage of the rigid frame of existing mannequins is the limitation it imposes on the ability for discreet storage.

In sum, prior to the present invention, handheld devices could be used in a natural position of hands-free body movement, while the mannequins' rigidity lacked the versatility and discreetness of handheld penile stimulation devices so users would have to buy multiple mannequins in order to have different experiences. Furthermore, though the outer surface material of the mannequins looks realistic, it does not have the supple quality of human flesh, is difficult to clean, and repeat usage or excess force causes tears and compression marks, all while attempts to discreetly store the mannequins could be frustrated by the rigid frame incorporated in such mannequins.

As can be seen, there is a need for a mannequin of a human torso adapted to interchangeably retain at least one of a plurality of penile stimulation devices for functionally simulating intercourse in combination with said mannequin.

### SUMMARY OF THE INVENTION

In one aspect of the present invention, a special purpose mannequin includes a lower torso portion defining a torso cavity communicating with a cavity opening; a sleeve lining the torso cavity so that the sleeve extends to at least the cavity opening; and a drawstring extending between two opposing ends, wherein the drawstring circumscribing a peripheral portion of the sleeve, wherein the peripheral portion is disposed in the torso cavity near the cavity opening, wherein the two opposing ends of the drawstring protrude from the lower torso portion but not the cavity opening, wherein pulling the two ends selectively decreases a perimeter of the peripheral portion, wherein the lower torso forms the shape of a human torso, wherein the lower torso further comprises a shell covering, wherein the shell covering comprises a plush material that is stain and soil repellent material, wherein the lower torso further comprises a deformable stuffing between the shell covering and the torso cavity, wherein the lower torso provides two outlet holes, one outlet hole for each of the two opposing end of the drawstring to protrude from, wherein the sleeve terminates in a distal end that protrudes from the cavity opening, and wherein the distal end lays along a portion of the shell covering, and wherein the apparatus does not house a rigid frame, wherein the sleeve is adapted to slidably receive at least one penile stimulation device.

These and other features, aspects and advantages of the present invention will become better understood with reference to the following drawings, description and claims.

### BRIEF DESCRIPTION OF THE DRAWINGS

FIG. 1 is a front perspective view of an exemplary embodiment of the present invention;

FIG. 2 is a bottom perspective view of an exemplary embodiment of the present invention;

FIG. 3 is a cross-sectional view of an exemplary embodiment of the present invention, taken along line 3-3 of FIG. 2; and

FIG. 4 is a cross-sectional exploded view of an exemplary embodiment of the present invention, demonstrating an operative effect.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a mannequin of a human torso adapted to retain otherwise handheld devices for simulation purposes. The mannequin may have a plush shell covering filled with polymer stuffing except for a cavity therein, wherein the cavity communicates to a cavity opening defined by the shell covering. An elastic sleeve may be dimensioned and adapted to line the cavity yet protrude from the cavity opening, so that the sleeve opening is concomitant with the cavity opening. Operatively engaged along a peripheral portion of the sleeve, slightly inward for the sleeve opening, a peripheral drawstring adapted to selectively decrease the peripheral portion of the sleeve is disposed to removably retain the handheld device within the sleeve.

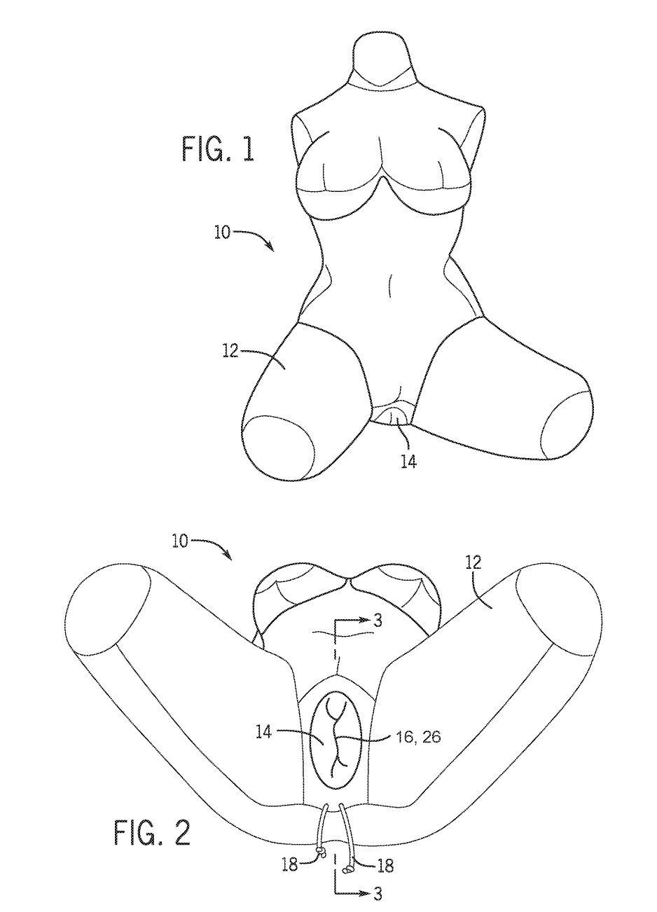

Referring to FIGS. 1 through 4, the present invention may include a mannequin 10 in the shape or form of a human torso. In an embodiment, the mannequin 10 is the shape of a female human, having at least a lower torso representative of a crotch area of the female human. The lower torso includes a shell covering 12 defining its outer shape, wherein the shell covering 12 is filled with a torso stuffing 22. Defined within the torso stuffing 22 is a torso cavity 24 near the crotch area. A crotch opening 16 may be defined by the shell covering 12 at the crotch area, so that the crotch opening 16 communications with the torso cavity 24. The shell covering 12 may be made of a stain and soil repellent material that is soft, durable, and readily washable. The torso stuffing 22 may include polymer fibers that compress and expand in response to the exertion and release of pressure to simulate the supple quality of human flesh. This ability to compress and expand enables the mannequin 10 to be discreetly stored in a space much smaller than its operable size, especially because of a lack of a rigid frame incorporated therein.

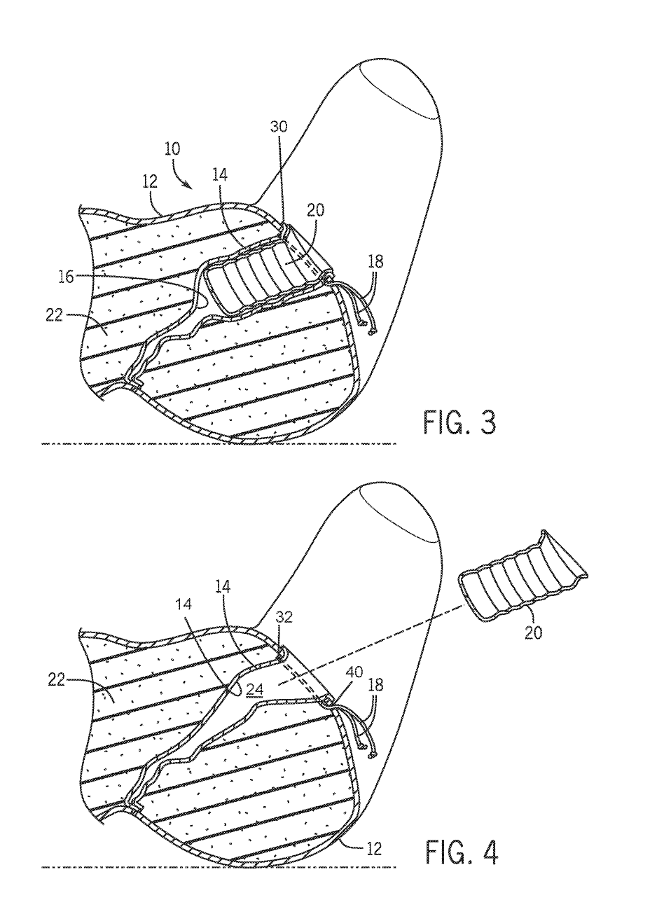

The present invention may include a sleeve 14 having an elongated proximal end and a distal end 30, wherein the sleeve 14 is dimensioned and adapted to line the torso cavity 24 so that the distal end 30 protrudes through the crotch opening 16, thereby providing a concomitant sleeve opening 26. The distal end 30 may be adapted to unfold and/or lay onto the portion of the shell covering 12 circumscribing the crotch opening 16, as illustrated in FIGS. 3 and 4. The sleeve 14 may be anchored, for example by sewing, within the torso cavity 24.

A drawstring 18 may engage a draw periphery 32 of the sleeve 14 near the distal end 30 so as to be inward of the crotch/sleeve opening 16/26 and within the torso cavity 24. The drawstring 18 may be sewn in a circumferential pocket along the draw periphery 32 of the sleeve 14 or otherwise be adapted so that pulling on opposing ends of the drawstring 18 selectively decreases the circumference and/or perimeter along the draw periphery 32 of the sleeve 14. The mannequin 10 provides two outlet holes 40, one for each end of the drawstring 18 to protrude out of from the torso cavity 24, whereby a user may selectively pull on the ends of the drawstring 18 external to the torso cavity 24. The drawstring 18 may be cross-stitched rope. The drawstring 18 may be dimensioned so that the external ends may cross over each other so as to tie and secure the decreased draw periphery 32 about an object, such as a penile stimulation device 20. The sleeve 14 may be made of an elastic material that compresses and expands to compliment the size of the object placed inside.

The torso cavity 24 and engaged sleeve 14 may be dimensioned and adapted to slidably receive at least one of a plurality of handheld penile stimulating devices 20, whereby the user may selectively pull the external ends of the drawstrings 18 so as to removably retain the at least one of a plurality of handheld penile devices 20 within the torso cavity 24 and engaged sleeve 14.

A method of using the present invention may include providing the mannequin 10 as disclosed and described above. The user may slide a first desired penile stimulating device 20 through the crotch/sleeve opening 16, 26 and into the sleeve-14-engaged torso cavity 24 so that the business end of the first penile stimulating device 20 may be generally align with the crotch/sleeve opening 16/26. Subsequent to employing the first desired penile stimulating device 20, the user may untie the drawstring 18 and remove the first desired penile stimulating device 20 so as to interchange it with a second desired penile stimulating device 20 similarly slid into and disposed within the sleeve-14-engaged torso cavity 24.

It should be understood, of course, that the foregoing relates to exemplary embodiments of the invention and that modifications may be made without departing from the spirit and scope of the invention as set forth in the following claims.

What is claimed is:

1. An apparatus, comprising:
a lower torso portion defining a torso cavity communicating with a cavity opening;
a sleeve lining the torso cavity so that the sleeve extends to at least the cavity opening; and
a drawstring extending between two opposing ends, wherein the drawstring circumscribing a peripheral portion of the sleeve, wherein the peripheral portion is disposed in the torso cavity near the cavity opening, wherein the two opposing ends of the drawstring protrude from the lower torso portion but not the cavity opening, and wherein pulling the two ends selectively decreases a perimeter of the peripheral portion.

2. The apparatus of claim 1, wherein the lower torso forms the shape of a human torso.

3. The apparatus of claim 2, wherein the lower torso further comprises a shell covering, wherein the shell covering comprises a plush material that is stain and soil repellent material.

4. The apparatus of claim 3, wherein the lower torso further comprises a deformable stuffing between the shell covering and the torso cavity.

5. The apparatus of claim 4, wherein the lower torso provides two outlet holes, one outlet hole for each of the two opposing end of the drawstring to protrude from.

6. The apparatus of claim 5, wherein the sleeve terminates in a distal end that protrudes from the cavity opening, and wherein the distal end lays along a portion of the shell covering.

7. The apparatus of claim 6, wherein the apparatus does not house a rigid frame.

8. The apparatus of claim 7, wherein the sleeve is adapted to slidably receive at least one handheld object.

9. The apparatus of claim 8, wherein the at least one handheld object is a penile stimulation device.
